(19) United States
(12) Patent Application Publication
(10) Pub. No.: US 2023/0161836 A1
(43) Pub. Date: May 25, 2023

(54) SIGNAL PROCESSING METHOD BASED ON MATHEMATICAL MORPHOLOGY WITH SPARSE STRUCTURAL ELEMENTS

(71) Applicant: South China University of Technology, Guangzhou (CN)

(72) Inventors: Qinghua Wu, Guangzhou (CN); Luliang Zhang, Guangzhou (CN); Mingchang Huang, Guangzhou (CN)

(21) Appl. No.: 18/094,978

(22) Filed: Jan. 9, 2023

Related U.S. Application Data
(63) Continuation of application No. PCT/CN2020/122113, filed on Oct. 20, 2020.

(30) Foreign Application Priority Data
Jul. 8, 2020 (CN) 202010651047.X

(51) Int. Cl. G06F 17/17

(52) U.S. Cl. CPC G06F 17/17

(57) ABSTRACT

A signal processing method based on mathematical morphology with sparse structural elements is disclosed, including the steps of: 1) building sparse structural elements; 2) performing morphological filtering on a signal by using the sparse structural elements; 3) improving a filtering effect for a filtering result by using a multi-stage sparse algorithm or a two-stage sparse algorithm; 4) building dissociative structural elements and a bipolar morphological gradient; and 5) performing a bipolar morphological gradient extraction on the signal by using the dissociative structural elements. The method can effectively reduce the calculation amount and calculation time of mathematical morphology signal processing and enhance the amplitude of the morphological gradient.

### CROSS REFERENCE TO RELATED APPLICATIONS

The present application is a Continuation Application of PCT Application No. PCT/CN2020/122113 filed on Oct. 20, 2020, which claims the benefit of Chinese Patent Application No. 202010651047.X filed on Jul. 8, 2020. All the above are hereby incorporated by reference in their entirety.

### FIELD OF THE INVENTION

The present disclosure relates to the technical field of signal processing, and in particular, to a signal processing method based on mathematical morphology with sparse structural elements.

### BACKGROUND OF THE INVENTION

In the field of signal processing, mathematical morphology is very effective for filtering, signal decomposition, gradient extraction, peak valley extraction, and other operations. Compared with other signal processing methods such as Fourier transform and wavelet transform, mathematical morphology has a smaller calculation amount as only addition, subtraction, and comparison operation are involved. A morphological filter has been widely used in baseline correction and noise suppression of an electrocardiogram signal, noise suppression of a rolling bearing defect feature extraction, etc. However, morphological gradient, morphological wavelet, and multi-resolution morphology are commonly used in singularity detection of electrocardiograms, transformer inrush currents, transmission line faults, and other scenarios.

In many cases, researchers often pay more attention to exploring application scenarios of mathematical morphology than to further developing the theory of mathematical morphology itself, especially for structural elements in mathematical morphology. So far, for the study of structural elements in mathematical morphology, some scholars have proposed the concept of soft morphology, which divides structural elements into two parts: kernel and soft edge, enhancing the performance of the morphological filter in noisy environments, but substantially increasing the computational intensiveness of filtering. In addition, a fast method for computing morphological opening and closing operations is given in some literature, which effectively improves the speed of opening and closing operations. However, the algorithm requires that structural elements must be flat, and the speed increase of opening and closing operations is unpredictable. Others have decomposed structural elements and used hardware parallel computing to improve the speed, but this requires hardware support.

### SUMMARY OF THE INVENTION

The present disclosure is intended to overcome the disadvantages and shortcomings of the prior art, and proposes a signal processing method based on mathematical morphology with sparse structural elements, which can effectively reduce the calculation amount and calculation time of mathematical morphology signal processing and enhance the amplitude of the morphological gradient.

In order to achieve the above-mentioned object, the technical solution provided by the present disclosure is a signal processing method based on mathematical morphology with sparse structural elements, including the following steps:

1) building sparse structural elements;

2) performing morphological filtering on a signal by using the sparse structural elements; 3) improving the filtering effect by using a multi-stage sparse algorithm or a two-stage sparse algorithm;

4) building dissociative structural dissociative structural elements and a bipolar morphological gradient; and

5) performing a bipolar morphological gradient extraction on the signal by using the dissociative structural elements.

In step 1), features of the sparse structural elements are that there are two adjacent points with a lateral spacing greater than one in structural elements, or an abscissa of any one point therein is not zero; if spacings between every two adjacent points of the sparse structural elements are equal, each of the spacings is defined as a sparsity SP.

In step 3), the multi-stage sparse algorithm achieves an effect of smoothing the signal by using the structural elements of different sparsity multiple times, and the specific steps thereof are as follows:

3.1) in the first stage, processing an original signal by using the structural elements with a length of L and a sparsity of SP to obtain a first stage output; if the spacings between every two adjacent points of the sparse structural elements are equal, each of the spacings is defined as the sparsity SP;

3.2) in the m^{th} stage, processing a m−1^{th} stage output by using the structural elements with a length of ┌SP^{m-1}/L^{m-2}┐ and a sparsity of ┌SP^{m}/L^{m-1}┐ to obtain a m^{th} stage output, entering the next step until the sparsity of the next stage is ┌SP^{m+1}/L^{m}┐=1, and calculating M=┌ln(SP)/ln(L/SP)┐, where m=2, . . . , M; and

3.3) in the M+1^{th} stage, processing a M^{th} stage output by using the structural elements with a length of ┌SP^{M}/L^{M-1}┐ and a sparsity of 1 to obtain a final output.

In step 3), the two-stage sparse algorithm achieves the effect of smoothing the signal by successively using the structural elements with the sparsity of non-one and the sparsity of one for two times, and the specific steps thereof are as follows:

3.1) in the first stage, processing the original signal by using the structural elements with the length of L and the sparsity of SP to obtain the first stage output; if the spacings between every two adjacent points of the sparse structural elements are equal, each of the spacings is defined as the sparsity SP; and

3.2) in the second stage, processing the first stage output by using the structural elements with the length of SP and the sparsity of 1 to obtain the final output.

In step 4), the dissociative structural dissociative structural elements are special cases of the sparse structural elements, and the abscissae of all elements in the dissociative structural dissociative structural elements are greater than zero or less than zero.

In step 4), the bipolar morphological gradient is shown in the following equation:

G_{b}(f,g)=f⊕g−fΘg+fΘĝ−f⊕ĝ

ĝ={ĝ(−s)=g(s),s∈D_{g}}

In the equation, G_{b} represents the bipolar morphological gradient, ⊕ and Θ are a morphological grayscale dilation operator and a grayscale erosion operator, respectively, and f, g, and ĝ represent a processed signal, the structural elements and structural elements symmetrical about a longitudinal axis, respectively; D_{g} is a domain of the structural elements g, and s is a domain variable of the structural elements.

Compared with the prior art, the present disclosure has the following advantages and beneficial effects.

1. The method of the present disclosure first proposes the concept of the sparse structural elements, and in signal processing, compared with a morphological operation based on traditional structural elements, the morphological operation based on the sparse structural elements has a faster response speed and a smaller calculation amount.

2. The method of the present disclosure first proposes the concept of the dissociative structural dissociative structural elements, and builds a bipolar morphological gradient operator. In signal processing, performing the bipolar morphological gradient extraction by using the dissociative structural elements can reduce the calculation amount and increase the extracted gradient at the same time.

3. The method of the present disclosure proposes the multi-stage sparse algorithm and the two-stage sparse algorithm, which optimizes the morphological filtering effect based on the sparse structural elements. Compared with a traditional morphological filtering method, the multi-stage sparse algorithm and the two-stage sparse algorithm reduce the calculation time and ensure the filtering effect.

### BRIEF DESCRIPTION OF THE DRAWINGS

FIG. 1 is a schematic diagram of the three structural elements, the signal to be processed, and a reference signal used in embodiment 1;

FIG. 2 shows the results obtained by morphological filtering using each of the three structural elements in embodiment 1, and the results obtained by optimizing the morphological filtering of the sparse structural elements using the two-stage sparse algorithm and the multi-stage sparse algorithm;

FIG. 3 is a schematic diagram of the four structural elements used in embodiment 2; and

FIG. 4 is a transformer inrush current signal of embodiment 2 and morphological gradient features extracted by using each of the four structural elements.

### DETAILED DESCRIPTION OF THE EMBODIMENTS

The present disclosure will be further explained with reference to the specific embodiments.

### Embodiment 1

The present embodiment provides a signal processing method based on mathematical morphology with sparse structural elements and includes the following steps.

1) Sparse structural elements are built.

Features of the sparse structural elements are that there are two adjacent points with a lateral spacing greater than one in structural elements, or an abscissa of any one point therein is not zero; if spacings between every two adjacent points of the sparse structural elements are equal, each of the spacings is defined as a sparsity SP.

2) Morphological filtering is performed on a signal by using the sparse structural elements, where the formula of the morphological filtering is of the same form as the formula of traditional morphological filtering, but the structural elements used are sparse structural elements.

3) A filtering effect is improved for a filtering result by using a multi-stage sparse algorithm or a two-stage sparse algorithm, where:

the multi-stage sparse algorithm achieves an effect of smoothing the signal by using the structural elements of different sparsity multiple times, and the specific steps thereof are as follows.

3.1.1) In the first stage, an original signal is processed by using the structural elements with a length of L and a sparsity of SP to obtain a first stage output.

3.1.2) In the m^{th} stage, a m−1^{th} stage output is processed by using the structural elements with a length of ┌SP^{m-1}/L^{m-2}┐ and a sparsity of ┌SP^{m}/L^{m-1}┐ to obtain a m^{th} stage output. The m^{th} stage output enters the next step until the sparsity of the next stage is M=┌ln(SP)/ln(L/SP)┐, and M=┌ln(SP)/ln(L/SP)┐ is calculated, where m=2, . . . , M.

3.1.3) In the M+i^{th} stage, a M^{th} stage output is processed by using the structural elements with a length of ┌SP^{M}/L^{M-1}┐ and a sparsity of 1 to obtain a final output.

The two-stage sparse algorithm is a special case of the above-mentioned multi-stage sparse algorithm and achieves the effect of smoothing the signal by successively using the structural elements with the sparsity of non-one and the sparsity of one for two times, and the specific steps thereof are as follows.

3.2.1) In the first stage, the original signal is processed by using the structural elements with the length of L and the sparsity of SP to obtain the first stage output.

3.2.1) In the second stage, the first stage output is processed by using the structural elements with the length of SP and the sparsity of 1 to obtain the final output.

4) Dissociative structural elements and a bipolar morphological gradient are built. The dissociative structural elements are special cases of the sparse structural elements, and the abscissae of all elements in the dissociative structural elements are greater than zero or less than zero. The bipolar morphological gradient is shown in the following equation:

G_{b}(f,g)=f⊕g−fΘg+fΘĝ−f⊕ĝ

ĝ={ĝ(−s)=g(s),s∈D_{g}}

In the equation, G_{b} represents the bipolar morphological gradient, ⊕ and Θ are a morphological grayscale dilation operator and a grayscale erosion operator, respectively, and f, g, and ĝ represent a processed signal, the structural elements and structural elements symmetrical about a longitudinal axis, respectively; D_{g} is a domain of the structural elements g, and s is a domain variable of the structural elements.

5) A bipolar morphological gradient extraction is performed on the signal by using the dissociative structural elements.

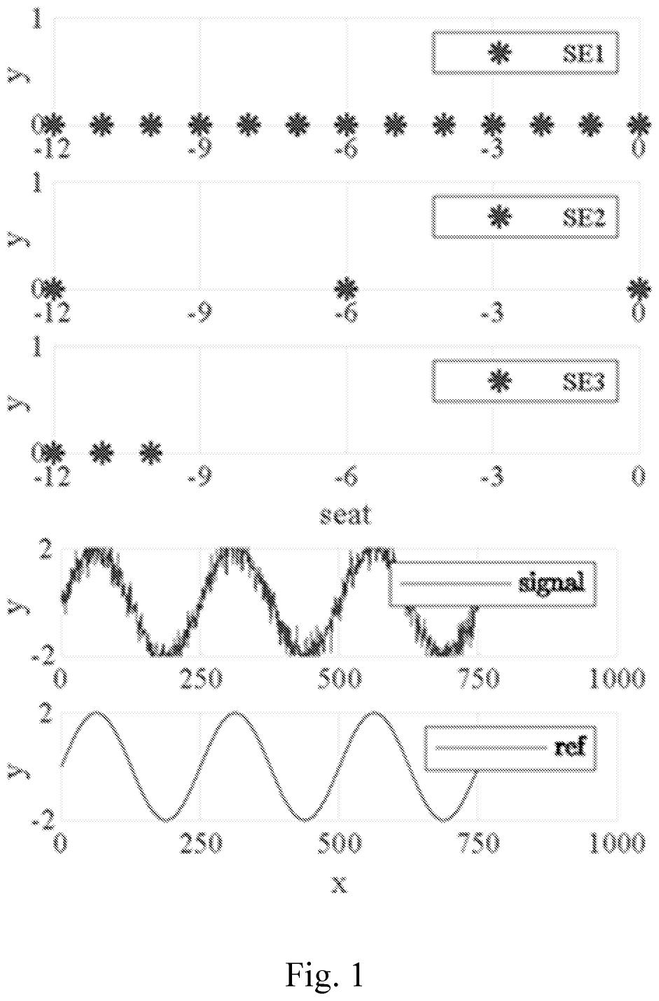

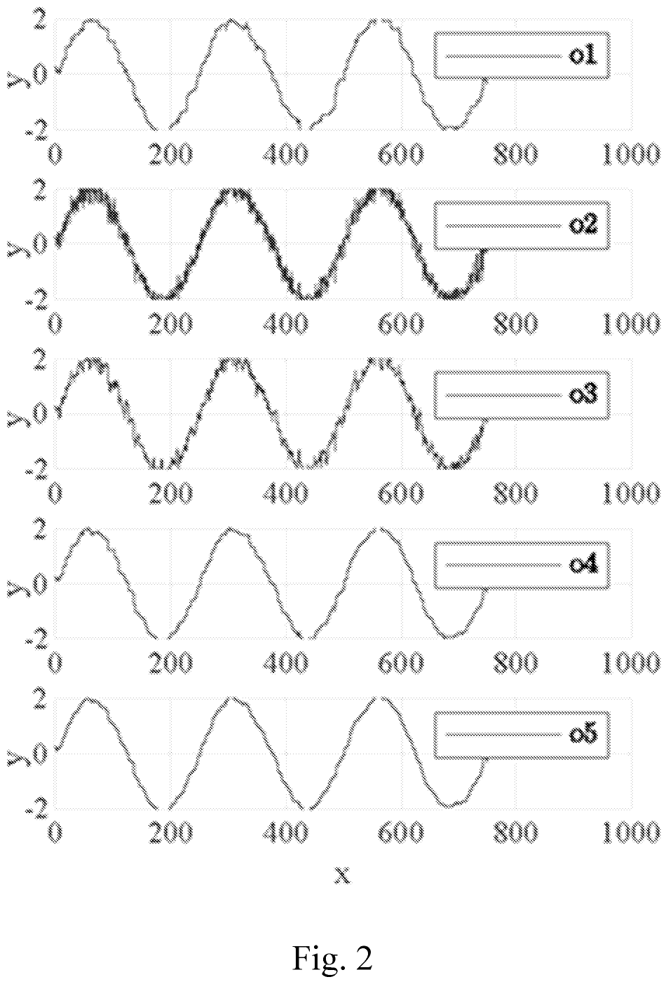

In the present embodiment, morphological filtering is performed on a sinusoidal signal added with 9 dB noise, and the three structural elements used, the signal to be processed, and the reference signal are shown in FIG. 1. SE1-SE3 in the figure represent the three structural elements used, signal represents the signal to be processed, and ref represents the reference signal. And the respective filtering results are shown in FIG. 2. o1-o3 in the figure are signals after filtering using traditional structural elements SE1, sparse structural elements SE2 and dissociative structural elements SE3, and o4 and o5 are results after morphological filtering of sparse structural elements adopting the two-stage sparse algorithm and the multi-stage sparse algorithm. By comparing these results, it can be seen that although the use of sparse structural elements for direct morphological filtering can effectively reduce the calculation time, the filtering effect is not ideal. But after adopting the two-stage sparse algorithm or the multi-stage sparse algorithm, the filtering effect can be largely repaired. In the aspect of morphological filtering, dissociative structural elements have little effect.

### Embodiment 2

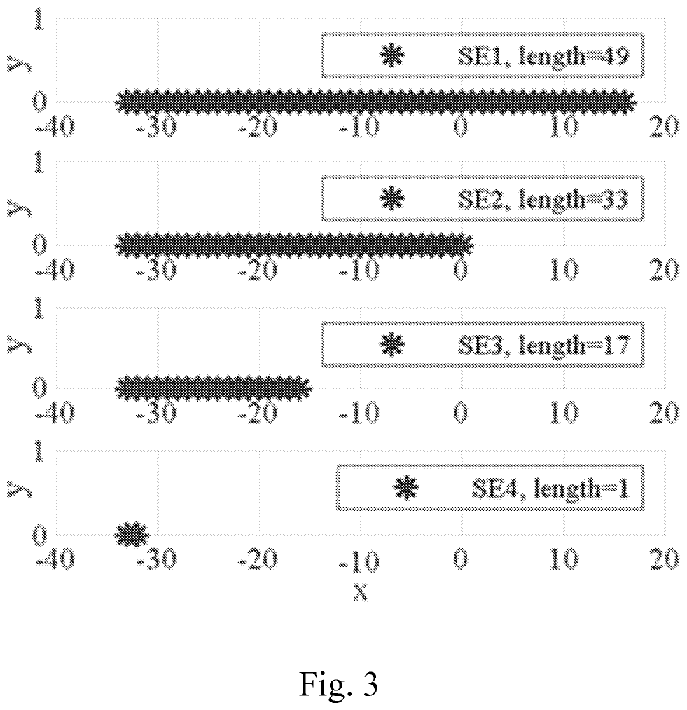

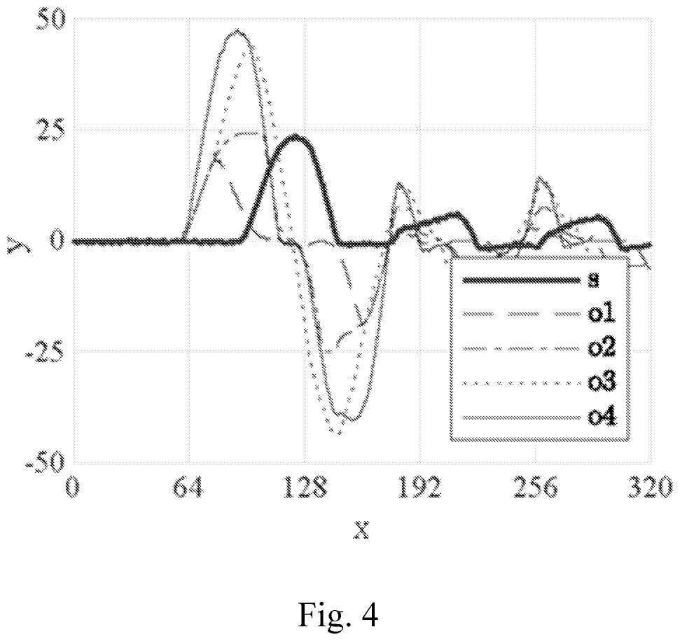

Different from embodiment 1, the embodiment extracts the gradient feature from the inrush current signal of the transformer, and the schematic diagrams of the compared four structural elements are shown in FIG. 3. SE1-SE4 in the figure represent the four structural elements, and length represents the length of the structural elements used. The transformer inrush current signal and the morphological gradient signals extracted from each of these four structural elements are shown in FIG. 4. s and o1-o4 in the figure represent the original signal and the four morphological gradient signals extracted from SE1-SE4, respectively. By comparing the morphological gradients extracted from the traditional structural elements SE1, SE2 and the dissociative structural elements SE3, SE4, it can be seen that the dissociative structural elements can enhance the gradient feature and reduce the calculation amount while keeping the distance between the origin and the farthest end of the structural elements unchanged. Compared with the gradient extraction of the traditional structural elements, the best case of using the dissociative structural elements to extract morphological gradient in the embodiment can almost double the maximum value of the gradient, and the calculation amount is only 1/17 of the original.

In summary, the method of the present disclosure proposes new structural elements-sparse structural elements and dissociative structural elements, and on this basis, morphological gradient extractions and morphological filtering operations on the signal are performed to realize the feature extractions and smoothing of the signal. And the filtering effect is improved by using the multi-stage sparse algorithm and the two-stage sparse algorithm. In summary, the method of the present disclosure is based on the sparse structural elements, reduces the calculation amount and calculation time of mathematical morphology signal processing, and enhances the amplitude of the morphological gradient, which is worth popularizing.

The above-mentioned embodiments are only the better embodiments of the present disclosure, and are not intended to limit the scope of the present disclosure. Therefore, all variations according to the shape and principle of the present disclosure should be covered within the scope of the present disclosure.

1. A signal processing method based on mathematical morphology with sparse structural elements, comprising the following steps:
1) building sparse structural elements;
2) performing morphological filtering on a signal by using the sparse structural elements;
3) improving a filtering effect for a filtering result by using a multi-stage sparse algorithm or a two-stage sparse algorithm;
4) building dissociative structural elements and a bipolar morphological gradient; and
5) performing a bipolar morphological gradient extraction on the signal by using the dissociative structural elements.

2. The method according to claim 1, wherein in step 1), features of the sparse structural elements are that there are two adjacent points with a lateral spacing greater than one in structural elements, or an abscissa of any one point therein is not zero; if spacings between every two adjacent points of the sparse structural elements are equal, each of the spacings is defined as a sparsity SP.

3. The method according to claim 1, wherein in step 3), the multi-stage sparse algorithm achieves an effect of smoothing the signal by using the structural elements of different sparsity multiple times, and the specific steps thereof are as follows:
3.1) in the first stage, processing an original signal by using the structural elements with a length of L and a sparsity of SP to obtain a first stage output; if the spacings between every two adjacent points of the sparse structural elements are equal, each of the spacings is defined as the sparsity SP;
3.2) in the m^{th} stage, processing a m−1^{th} stage output by using the structural elements with a length of ┌SP^{m-1}/L^{m-2}┐ and a sparsity of ┌SP^{m}/L^{m-1}┐ to obtain a m^{th} stage output, entering the next step until the sparsity of the next stage is ┌SP^{m+1}/L^{m}┐=1, and calculating M=┌ln(SP)/ln(L/SP)┐, where m=2, . . . , M; and
3.3) in the M+1^{th} stage, processing a M^{th} stage output by using the structural elements with a length of ┌SP^{M}/L^{M-1}┐ and a sparsity of 1 to obtain a final output.

4. The method according to claim 1, wherein in step 3), the two-stage sparse algorithm achieves the effect of smoothing the signal by successively using the structural elements with the sparsity of non-one and the sparsity of one for two times, and the specific steps thereof are as follows:
3.1) in the first stage, processing the original signal by using the structural elements with the length of L and the sparsity of SP to obtain the first stage output; if the spacings between every two adjacent points of the sparse structural elements are equal, each of the spacings is defined as the sparsity SP; and
3.2) in the second stage, processing the first stage output by using the structural elements with the length of SP and the sparsity of 1 to obtain the final output.

5. The method according to claim 1, wherein in step 4), the dissociative structural elements are special cases of the sparse structural elements, and the abscissae of all elements in the dissociative structural elements are greater than zero or less than zero.

6. The method according to claim 1, wherein in step 4), the bipolar morphological gradient is shown in the following equation:
G_{b}(f,g)=f⊕g−fΘg+fΘĝ−f⊕ĝ
ĝ={ĝ(−s)=g(s),s∈D_{g}}
where, G_{b} represents the bipolar morphological gradient, ⊕ and Θ are a morphological grayscale dilation operator and a grayscale erosion operator, respectively, and f, g and ĝ represent a processed signal, the structural elements, and structural elements symmetrical about a longitudinal axis, respectively; D_{g} is a domain of the structural elements g, and s is a domain variable of the structural elements.
